(19) United States
(12) Patent Application Publication
(10) Pub. No.: US 2017/0225921 A1
(43) Pub. Date: Aug. 10, 2017

(54) ELEVATOR CAR LOCATION SENSING SYSTEM

(71) Applicant: OTIS ELEVATOR COMPANY, Farmington, CT (US)

(72) Inventors: Bradley Armand Scoville, Farmington, CT (US); Daryl J. Marvin, Farmington, CT (US)

(21) Appl. No.: 15/328,647

(22) PCT Filed: Jul. 28, 2015
(86) PCT No.: PCT/US2015/042539

§ 371 Date: Jan. 24, 2017

Related U.S. Application Data
(60) Provisional application No. 62/029,766, filed on Jul. 28, 2014.

(51) Int. Cl. B66B 1/34; B66B 1/46; G01C 5/06; B66B 5/00

(52) U.S. Cl. CPC B66B 1/3492; B66B 5/0018; B66B 1/468; G01C 5/06; B66B 2201/4653; B66B 2201/101

(57) ABSTRACT

An elevator car location sensing system includes at least one first barometric pressure sensor disposed at a sensor position. The first barometric pressure sensor is configured to measure at least one first barometric pressure at the sensor position. An elevator control module is configured to electrically communicate with at least one mobile terminal device that is movable among a plurality of different altitudes. The elevator control module receives a second barometric pressure from the mobile terminal device located at a current altitude, and determines the current altitude based on a comparison between the first barometric pressure and the second barometric pressure.

### TECHNICAL FIELD

The present invention relates generally to elevator systems, and more particularly, to elevator control systems.

### BACKGROUND

Conventional elevator car dispatching systems require a mechanism of determining passenger location. This may be provided by the use of hard-wired destination entry devices, such as touch screen kiosks, which have a known and fixed physical location.

Wireless and mobile terminal devices that utilize software applications (i.e., “apps”) have become popular device which allow for controlling various electro-mechanical systems. For example, a smartphone can include an app configured to remotely interact with destination dispatching services of an elevator system. Such interaction, however, is prone to error. For example, a passenger of an elevator system may mistakenly indicate on her cell phone that she is located on the fourth floor of a building, when in reality she is on the seventh floor of the building. In yet another illustrative scenario, a second passenger requesting elevator service may intentionally call an elevator car to an incorrect floor within a building. Thus, controlling an elevator car without considering the actual location of the passenger can cause inefficient operation of the elevator system.

### SUMMARY

According to embodiment, an elevator car location sensing system includes at least one first barometric pressure sensor disposed at a sensor position. The first barometric pressure sensor is configured to measure at least one first barometric pressure at the sensor position. An elevator control module is configured to electrically communicate with at least one mobile terminal device that is movable among a plurality of different altitudes. The elevator control module receives a second barometric pressure from the mobile terminal device located at a current altitude, and determines the current altitude based on a comparison between the first barometric pressure and the second barometric pressure.

The elevator location sensing system includes the following additional features:

a feature wherein at least one elevator car configured to move vertically among a plurality of different floors, the at least one first barometric pressure sensor configured to measure a first barometric pressure at each floor, and wherein the elevator control module is configured to determine a current altitude of the elevator car corresponding to a respective floor based on the measured first barometric pressure output from the at least one second barometric pressure sensor;

a feature wherein the elevator control module receives the second barometric pressure from the at least one mobile terminal device, determines a current floor of the at least one mobile terminal device based on the second barometric pressure, and commands the at least one elevator car to move to the current floor without receiving a call from the at least one elevator car;

a feature wherein the elevator control module generates an altitude table populated with a plurality of altitude values corresponding to a respective floor;

a feature wherein the elevator control module determines the current floor of the least one mobile terminal device based on a comparison between the determined current altitude and the altitude table;

a feature wherein the at least one first barometric pressure sensor is coupled to a respective elevator car, and is configured to measure the first barometric pressure at each respective floor;

a feature wherein the at least one first barometric pressure sensor includes a plurality of fixed barometric pressure sensors, each fixed barometric pressure sensor disposed at a respective floor; and

a feature wherein the current altitude is based on the equation:

$$d = \frac{- kT}{mg} ln ( \frac{Puser}{Pref} ) ,$$

where d is the altitude of the mobile terminal device, m is a mass of one molecule, g is a gravitational acceleration, k is Boltzmann's constant value, T is temperature, P_{USER} is the pressure measured by the mobile terminal device, and P_{REF} is reference pressure measured by the second pressure sensor.

According to another embodiment, a method of locating a vertical position of a mobile terminal device comprises determining a plurality of barometric pressures at different respective altitudes via the mobile terminal device. The method further includes determining at least one second barometric pressure via a second barometric pressure sensor located at a sensor position located remotely from the mobile terminal device. The method further includes determining a current altitude of the mobile terminal device based on a comparison between the measured first barometric pressure and the measured second barometric pressure.

The method includes the following additional features:

moving at least one elevator car vertically among a plurality of different floors, determining a second barometric pressure at each floor; and determining a current altitude of the elevator car based on the measured second barometric pressure output from the at least one second barometric pressure sensor;

determining the measured first barometric pressure of the at least one mobile terminal device, determining a current floor of the at least one mobile terminal device based on the measured first barometric pressure, and moving the at least one elevator car to the current floor of the mobile terminal device without receiving a call from the at least one elevator car;

generating an altitude table populated with a plurality of altitude values corresponding to a respective floor, determining a current altitude of the at least one mobile terminal device based on the measured first barometric pressure, and determining the current floor of the least one mobile terminal device based on a comparison between the current altitude and the altitude table;

a feature wherein the at least one second barometric pressure sensor is coupled to a respective elevator car to measure the second barometric pressure at each respective floor;

a feature wherein the at least one second barometric pressure sensor includes a plurality of fixed barometric pressure sensors, each fixed barometric pressure sensor disposed at a respective floor; and

a feature of determining the current altitude based on the equation:

$$d = \frac{- kT}{mg} ln ( \frac{Puser}{Pref} ) ,$$

where d is the altitude of the mobile terminal device, m is a mass of one molecule, g is a gravitational acceleration, k is Boltzmann's constant value, T is temperature, P_{USER} is the pressure measured by the mobile terminal device, and P_{REF} is reference pressure measured by the second pressure sensor.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a passenger vertical location sensing system according to an embodiment;

FIG. 2 illustrates a passenger vertical location sensing system according to another embodiment;

FIG. 3 illustrates a passenger vertical location sensing system according to still another embodiment;

FIG. 4 is a flow diagram illustrating a method of locating a vertical position of a user of an elevator system according to an embodiment; and

FIG. 5 is a flow diagram illustrating a method of locating a vertical position of a user of an elevator system according to another embodiment.

### DETAILED DESCRIPTION OF THE INVENTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, an electronic processor (shared, dedicated, or group) and memory that executes one or more software or firmware programs, a combinational logic circuit, and/or other suitable components that provide the described functionality.

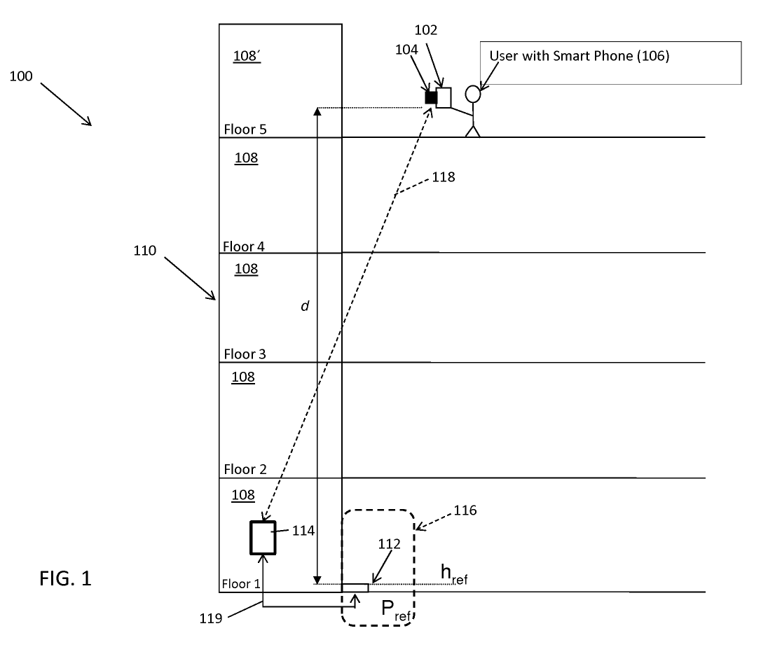

Referring now to FIG. 1, a passenger vertical location sensing system 100 is illustrated according to an embodiment. The passenger vertical location sensing system 100 includes at least one mobile terminal device 102 having a first barometric pressure sensor 104 installed thereon. The mobile terminal device 102 includes one or more electronic control modules configured to process various algorithms and computer software program instructions as understood by one of ordinary skill in the art. The mobile terminal device 102 may be constructed as various electronic devices including, but not limited to, a smartphone, a smartwatch, a computer tablet, etc. In this manner, the mobile terminal device 102 is configured to move among a plurality of different altitudes and measure a first barometric pressure realized by the mobile terminal device 102 at a particular current altitude. For example, a user 106 of a mobile terminal device 102 can move between a plurality of different floors 108 of a building 110 thereby realizing different respective altitudes. While the user 106 moves between the floors 108, the barometric pressure sensor 104 measures the current barometric pressure (P_{USER}) realized by a user 106 of the mobile terminal device 102 located at a current floor 108′. Based on the location of the mobile terminal device 102, the passenger vertical location sensing system 100 can determine the location of the user 106 as discussed in greater detail below.

The passenger vertical location sensing system 100 further includes at least one second barometric pressure sensor 112 and an elevator control module 114. The second barometric pressure sensor 112 is disposed at a sensor position 116 located remotely from the at least one mobile terminal device 102. The second barometric pressure sensor 112 is configured to measure at least one second barometric pressure (P_{REF}) at the sensor position 116.

The elevator control module 114 is in electrical communication with one or more mobile terminal devices 102 and the second barometric pressure sensor 112. A first pressure signal 118 indicative of the current barometric pressure (P_{USER}) is received from the mobile terminal device 118. The first pressure signal 118 may be communicated to the elevator control module 114 in response to a command manually input to the mobile terminal device 102 and/or automatically communicated to the elevator control module 114 in response to executing a pressure measurement. A second pressure signal 118 indicative of the second barometric pressure (P_{REF}) is received from second barometric pressure sensor 112. According to an embodiment, the elevator control module 114 determines a distance (d) between the mobile terminal device 102 and the second barometric pressure sensor 112 based on a comparison between the measured first barometric pressure (P_{USER}) and the measured second barometric pressure (P_{REF}). The distance (d) effectively indicates the altitude of the mobile terminal device 102 with respect to the second barometric pressure sensor 112.

According to the embodiment illustrated in FIG. 1, the altitude of the mobile terminal device 102 is determined according to the following equation:

$$d = \frac{- kT}{mg} ln ( \frac{Puser}{Pref} ) \qquad ( 1 )$$

Where, “d” is the altitude of the mobile terminal device 102 with respect to the second barometric pressure sensor 112, “m” is a mass of one molecule, “g” is a gravitational acceleration, “k” is Boltzmann's constant value, “T” is temperature, P_{USER} is the pressure measured by the mobile terminal device 102, and P_{REF} is reference pressure measured by the second pressure sensor 112. The altitude of the mobile terminal device 102 may also be calibrated to take into account of the height of the second barometric pressure sensor 112 with respect to a lowest point of a respective floor 108. In this case, the total altitude (d_{TOTAL}) of the mobile terminal device 102 is determined according to the following equation:

d_{TOTAL}=d+h_{ref}, (2)

where “d” is the distance between the mobile terminal device 102 and the second barometric sensor 112, and “h_{ref}” is the height of the sensor with respect to the lowest point of a respective floor 108.

Once the altitude of the mobile terminal device 102 is determined, a lookup table (LUT) may be used to determine the floor at which the mobile terminal device 102 is located, thereby locating the respective user 106. The LUT may be stored in the mobile terminal device 102 and/or in an elevator control module 114. According to an embodiment, the LUT is populated with a plurality of altitude values or altitude ranges that are cross-referenced to a respective floor number 108 as indicated in Table (1) below.

TABLE (1)

| Height Range | Floor Number |
|---|---|
| d₁ ≦ d < d₂ | 1 |
| d₂ ≦ d < d₃ | 2 |
| d₃ ≦ d < d₄ | 3 |
| d₄ ≦ d < d₅ | 4 |
| d₅ ≦ d < d₆ | 5 |

Each altitude range includes a low range value and a high range value. The location (e.g., floor number) of a mobile terminal device 102 is determined by comparing the measured current altitude (d) of the mobile terminal device 102 with the various altitude ranges of the LUT. If, for example, the measured current altitude (d) falls within a first range (e.g., d₁≦d<d₂), a user 106 of the mobile terminal device 102 is determined to be located at floor number 1. If the user 106 moves position such that the measured current altitude (d) subsequently falls within a second range (e.g., d₃≦d<d₄), the user 106 is determined to be located at floor number 3. Although 5 floors are included in Table (1), it is appreciated that Table (1) may be based on a building having more or less floors without departing from the scope of the present inventive teachings. As described above, the LUT may be stored in the mobile terminal device 102 and/or the elevator control module 114. Therefore, the elevator control module 114 can directly determine the current location 108′ (e.g., floor number) of the user 106, or the mobile terminal device 102 can determine the location of the user 106 and electrically communicate the current location 108′ to the elevator control module 114 via wireless communication.

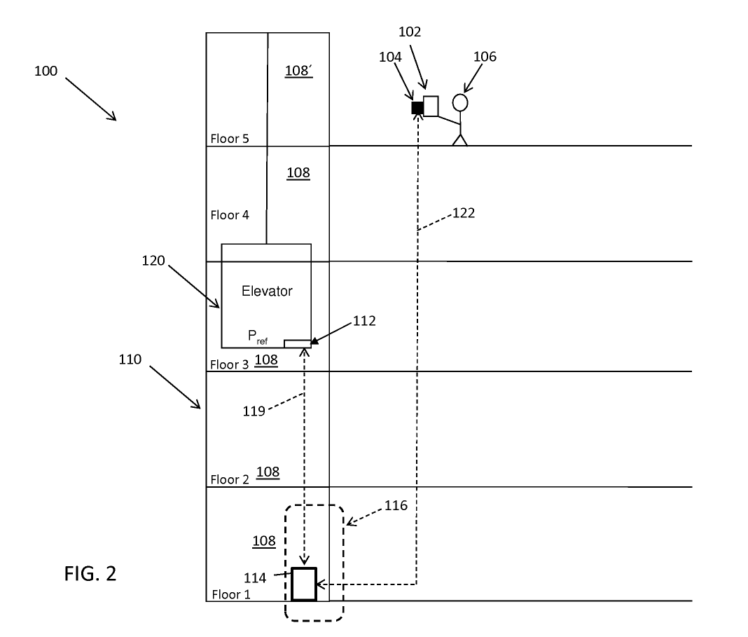

Referring now to FIG. 2, a system 100 is illustrated according to another embodiment. Similar reference numerals indicate like elements described in detail above. The system 100 of FIG. 2, however, includes an elevator car 120 having a second barometric pressure sensor 112 coupled thereto. As the elevator car 120 travels to each floor 108, the second barometric pressure sensor 112 measures the barometric pressure (P_{REF1}-P_{REF5}) of each floor 108. The second barometric pressure sensor 112 may then electrically communicate a second pressure signal 119 indicating one or more measured barometric pressure (P_{REF1}-P_{REF5}) to the elevator control module 114. The elevator control module 114 generates a LUT populated with a plurality of pressure values or pressure ranges that are cross-referenced to a respective floor number 108 as indicated in Table (2) below. The elevator control module 114 can dynamically update the LUT to account for weather changes that may affect the barometric pressure at each floor 108.

TABLE (2)

| Pressure Range | Floor Number |
|---|---|
| P₁ ≦ P_{USER} < P₂ | 1 |
| P₂ ≦ P_{USER} < P₃ | 2 |
| P₃ ≦ P_{USER} < P₄ | 3 |
| P₄ ≦ P_{USER} < P₅ | 4 |
| P₅ ≦ P_{USER} < P₆ | 5 |

Each pressure range includes a low range value and a high range value. According to the embodiment of FIG. 2, the first barometric pressure sensor 104 measures a current barometric pressure (P_{USER}) realized by the mobile terminal device 102. A pressure signal 122 indicative of the measured current barometric pressure 122 is then communicated by the mobile terminal device 102 to the elevator control module 114 via wireless communication. The elevator control module 114 compares the measured barometric pressure with the various pressure ranges of the LUT. If for example, the measured current pressure (P_{USER}) falls within a first range (e.g., P₁≦P_{USER}<P₂), a user 106 of the mobile terminal device 102 is determined to be located at floor number 1. If the user 106 moves position such that the measured current pressure (P_{USER}) subsequently falls within a second pressure range (e.g., P₃≦P_{USER}<Pₐ), the user 106 is determined to be located at floor number 3. As described above, the LUT may be stored in the mobile terminal device 102 and/or the elevator control module 114. Therefore, the elevator control module 114 can directly determine the current location 108′ (e.g., floor number) of the user 106, or the mobile terminal device 102 can determine the current location 108′ of the user 106 and can electrically communicate the determined current location 108′ to the elevator control module 114 via wireless communication.

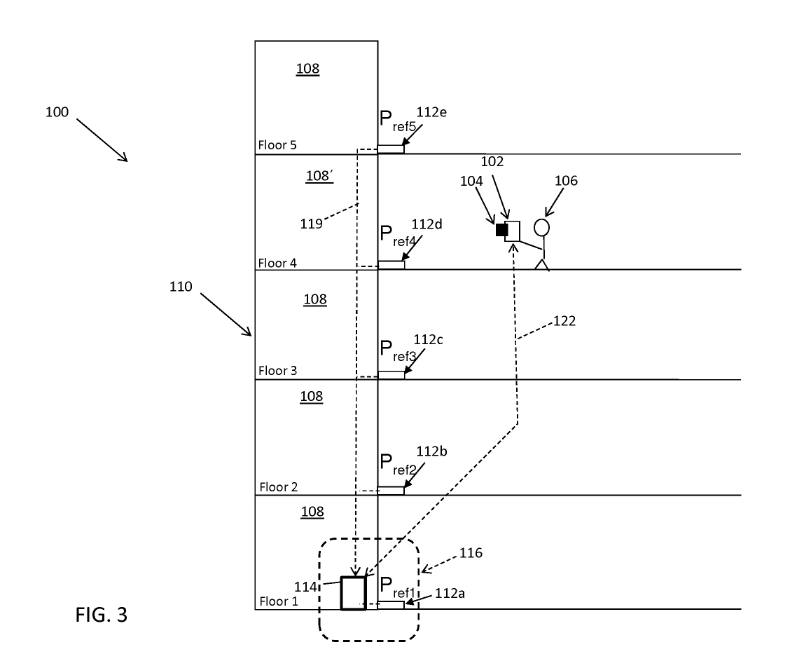

According to another similar embodiment illustrated in FIG. 3, a plurality of second barometric pressure sensors (112a-112e) are utilized instead of using a single second barometric pressure sensor coupled to the elevator car 120. More specifically, a second barometric pressure sensor 112a-112e is installed at each floor 108. In this manner, a second barometric pressure (P_{FLOOR1}-P_{FLOOR5}) of each floor is measured by a respective second barometric pressure sensor 112a-112e. The measured second barometric pressure is communicated by each second barometric pressure sensor 112a-112e to the elevator control module 114 via wired and/or wireless communication. The elevator control module 114 is configured to generate a LUT including a plurality of pressure values or pressure ranges as discussed in detail above.

The mobile terminal device 110 is configured to measure a current barometric pressure (P_{USER}) and communicate the measured current barometric pressure to the elevator control module 114. The elevator control module 114 compares the measured barometric pressure with the various pressure ranges of the LUT as described in detail above. For example, if the measured current pressure of the user 106 (P_{USER}) falls within a first range (e.g., P₁≦P_{USER}<P₂), a current floor 108′ of the user 106 is determined to be floor number 1. If the user 106 moves position such that the measured current pressure of the user (P_{USER}) subsequently falls within a second pressure range (e.g., P₃≦P_{USER}<Pₐ), the current floor 108′ of the user 106 is determined to be floor number 3. As described above, the LUT may be stored in the mobile terminal device 102 and/or the elevator control module 114. Therefore, the elevator control module 114 can directly determine the current location 108′ (e.g., floor number) of the user 106, or the mobile terminal device 102 can determine the current location 108′ of the user 106 and can electrically communicate the determined location 108′ to the elevator control module 114 via wireless communication as discussed in detail above. In this manner, the elevator control module 114 can automatically map a height of each floor in a building, as opposed to requiring a mechanic to manually setting fixture addresses using DIP switches as performed in conventional systems.

According to various embodiments described above, the passenger vertical location sensing system 100 can automatically receive the measured first barometric pressure from the at least one mobile terminal device 102, determine a current floor of the at least one mobile terminal device 102 based on the measured first barometric pressure, and automatically command at least one elevator car 120 to move to the current floor 108′ of the user 106 without receiving a call using the elevator car 120 and/or a control panel of the elevator system. In this manner, a user of the mobile terminal device 102 is not required to manipulate either elevator call system and/or the mobile terminal device itself.

According to another embodiment, a user 106 may manually request an elevator car be delivered to a selected floor. The elevator control module 114, however, may determine that the input floor requested by the user 106 does not match the current floor of the user 106 indicated by the barometric pressure by the user's mobile terminal device 102. Accordingly, the elevator control module may determine that the user 106 requested the elevator car 120 be delivered to an incorrect floor and output a control signal alerting the mobile terminal device 102 of the incorrect floor. This feature also may prevent a use's intent to send an elevator car 120 to an incorrect floor.

According to another embodiment, the elevator control module may determine how many users are located at each floor based on the measured barometric signals received from respective mobile terminal devices 102 located on a respective floor. Based on the number of users, the elevator control module 114 may organize the delivery of one or more elevator cars 120 to improve service. For example, the elevator control module 114 may determine the weight of one or more elevator cars. If the weight exceeds a weight threshold, the elevator control module 114 may command a fully loaded elevator to skip one or more floors, while diverting a less crowded elevator car to service the users located at the skipped floor.

Embodiments providing a feature of determining the pressure at each floor of a building achieve additional results. According to an embodiment, for example, a location of the user trapped in an elevator car may be quickly determined by comparing the barometric pressure measured by the mobile terminal device to the LUT stored in the elevator control module 114. Based on the comparison, the location of the elevator car with respect to the one or more floors can be determined.

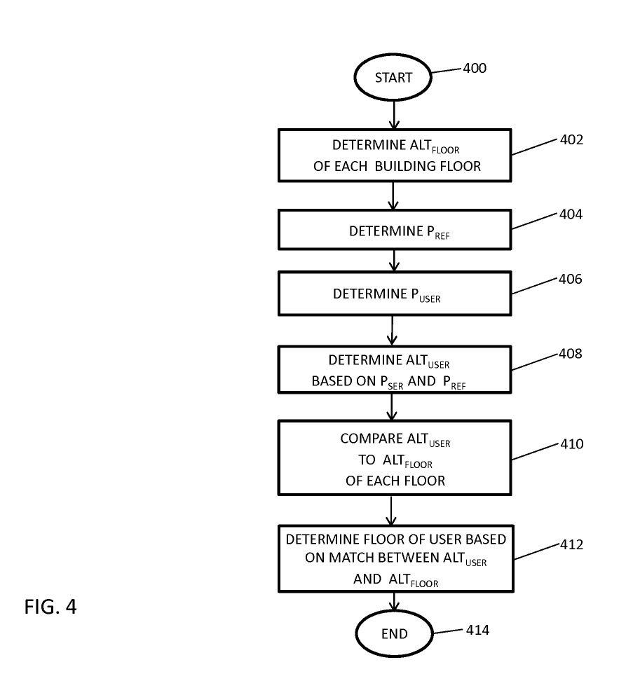

Referring to FIG. 4, a flow diagram illustrates a method of locating a vertical position of a user of an elevator system according to an embodiment. The method begins at operation 400, and at operation 402 an altitude (ALT_{FLOOR}) is assigned to each floor of a building. The altitude may include, for example, an altitude range corresponding to each respective floor. The altitude range indicates, for example, the altitude of a respective floor with respect to a reference location (e.g., first floor) of the building. At operation 404, a reference pressure (P_{REF}) is determined. The reference pressure is, for example, the barometric pressure existing at the reference location (e.g., first floor). At operation 406, a current barometric pressure (P_{USER}) realized by the user is determined. The current barometric pressure (P_{USER}) may include, for example, the barometric pressure of a particular area surrounding the user. A mobile terminal device possessed by the user, for example, may measure the current barometric pressure (P_{USER}). At operation 408, a current altitude (ALT_{USER}) of the user is determined based on the reference pressure (P_{REF}) and the current barometric pressure (P_{USER}) of the user. At operation 410, the current altitude (ALT_{USER}) of the user is compared to the altitude ranges (ALT_{FLOOR}) of all the floors. At operation 412, the current location (e.g., floor) of the user is determined when the current altitude (ALT_{USER}) matches a particular (ALT_{FLOOR}), and the method ends at operation 414.

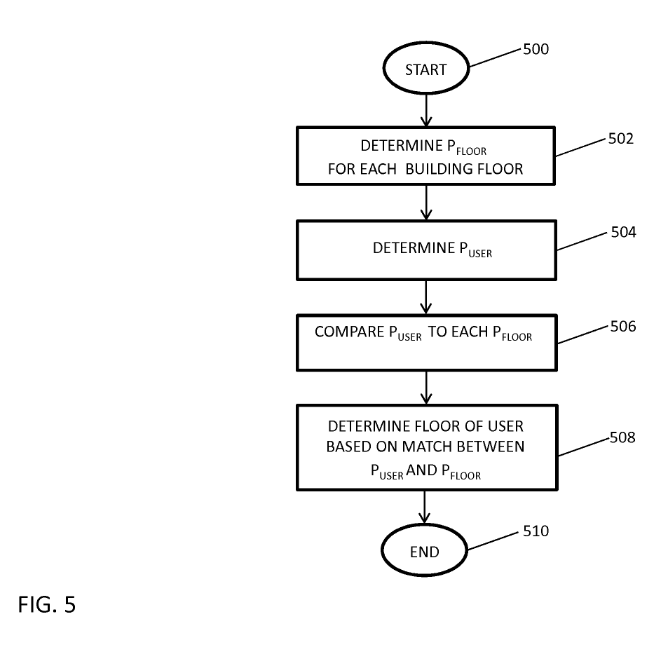

Turning now to FIG. 5, a flow diagram illustrates a method of locating a vertical position of a user of an elevator system according to another embodiment. The method begins at operation 500, and at operation 502 a barometric pressure (P_{FLOOR}) is determined for each floor of a building. The barometric pressure (P_{FLOOR}) of each floor may be determined using a barometric pressure sensor coupled to an elevator car. In this manner, the barometric pressure (P_{FLOOR}) of each floor is measured as the elevator car travels from a first location (e.g., the lowest floor of the building) to a second location (e.g., a highest floor of the building). According to another embodiment, a barometric sensor can be installed at each floor of the building. In this manner, the barometric pressure (P_{FLOOR}) at each floor can be determined using the respective barometric pressure sensor. At operation 504, a current barometric pressure (P_{USER}) of the user is determined. A mobile terminal device possessed by the user, for example, may measure the current barometric pressure (P_{USER}) of a particular area surrounding the user. At operation 506, the current pressure (P_{USER}) of the user 106 is compared to the barometric pressures (P_{FLOOR}) of each floor. At operation 508, the current location (e.g., floor) of the user is determined when the current barometric pressure (P_{USER}) of the user matches a barometric pressure (P_{FLOOR}) of a respective floor, and the method ends at operation 510.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator car location sensing system, comprising:
at least one first barometric pressure sensor disposed at a sensor position and configured to measure at least one first barometric pressure at the sensor position; and
an elevator control module configured to electrically communicate with at least one mobile terminal device that is movable among a plurality of different altitudes, receive a second barometric pressure from the mobile terminal device located at a current altitude, and determine the current altitude based on a comparison between the first barometric pressure and the second barometric pressure.

2. The elevator car location sensing system of claim 1, further comprising:
at least one elevator car configured to move vertically among a plurality of different floors, the at least one first barometric pressure sensor configured to measure a first barometric pressure at each floor,
wherein the elevator control module is configured to determine a current altitude of the elevator car corresponding to a respective floor based on the measured first barometric pressure output from the at least one second barometric pressure sensor.

3. The elevator car location sensing system of claim 2, wherein the elevator control module receives the second barometric pressure from the at least one mobile terminal device, determines a current floor of the at least one mobile terminal device based on the second barometric pressure, and commands the at least one elevator car to move to the current floor without receiving a call from the at least one elevator car.

4. The elevator car location sensing system of claim 3, wherein the elevator control module generates an altitude table populated with a plurality of altitude values corresponding to a respective floor.

5. The elevator car location system of claim 4, wherein the elevator control module determines the current floor of the least one mobile terminal device based on a comparison between the determined current altitude and the altitude table.

6. The elevator car location sensing system of claim 5, wherein the at least one first barometric pressure sensor is coupled to a respective elevator car, and is configured to measure the first barometric pressure at each respective floor.

7. The elevator car location sensing system of claim 5, wherein the at least one first barometric pressure sensor includes a plurality of fixed barometric pressure sensors, each fixed barometric pressure sensor disposed at a respective floor.

8. The elevator car location sensing system of claim 1, wherein the current altitude is based on the equation:
$$d = \frac{- kT}{mg} ln ( \frac{Puser}{Pref} ) ,$$
where d is the altitude of the mobile terminal device, m is a mass of one molecule, g is a gravitational acceleration, k is Boltzmann's constant value, T is temperature, P_{USER} is the pressure measured by the mobile terminal device, and P_{REF} is reference pressure measured by the second pressure sensor.

9. A method of locating a vertical position of a mobile terminal device, the method comprising:
determining a plurality of barometric pressures at different respective altitudes via the mobile terminal device;
determining at least one second barometric pressure via a second barometric pressure sensor located at a sensor position located remotely from the mobile terminal device; and
determining a current altitude of the mobile terminal device based on a comparison between the measured first barometric pressure and the measured second barometric pressure.

10. The method of claim 9, further comprising:
moving at least one elevator car vertically among a plurality of different floors;
determining a second barometric pressure at each floor; and
determining a current altitude of the elevator car based on the measured second barometric pressure output from the at least one second barometric pressure sensor.

11. The method of claim 10, further comprising:
determining the measured first barometric pressure of the at least one mobile terminal device;
determining a current floor of the at least one mobile terminal device based on the measured first barometric pressure; and
moving the at least one elevator car to the current floor of the mobile terminal device without receiving a call from the at least one elevator car.

12. The method of claim 11, further comprising generating an altitude table populated with a plurality of altitude values corresponding to a respective floor, determining a current altitude of the at least one mobile terminal device based on the measured first barometric pressure, and determining the current floor of the least one mobile terminal device based on a comparison between the current altitude and the altitude table.

13. The method of claim 12, wherein the at least one second barometric pressure sensor is coupled to a respective elevator car to measure the second barometric pressure at each respective floor.

14. The method of claim 12, wherein the at least one second barometric pressure sensor includes a plurality of fixed barometric pressure sensors, each fixed barometric pressure sensor disposed at a respective floor.

15. The method of claim 9, further comprising determining the current altitude based on the equation:
$$d = \frac{- kT}{mg} ln ( \frac{Puser}{Pref} ) ,$$
where d is the altitude of the mobile terminal device, m is a mass of one molecule, g is a gravitational acceleration, k is Boltzmann's constant value, T is temperature, P_{USER} is the pressure measured by the mobile terminal device, and P_{REF} is reference pressure measured by the second pressure sensor.
